(19) United States
(12) Patent Application Publication
(10) Pub. No.: US 2020/0021032 A1
(43) Pub. Date: Jan. 16, 2020

(54) ANTENNA DEVICE

(71) Applicant: MITSUBISHI ELECTRIC CORPORATION, Tokyo (JP)

(72) Inventors: Jun GOTO, Tokyo (JP); Toru FUKASAWA, Tokyo (JP)

(73) Assignee: MITSUBISHI ELECTRIC CORPORATION, Tokyo (JP)

(21) Appl. No.: 16/490,299

(22) PCT Filed: Mar. 29, 2017
(86) PCT No.: PCT/JP2017/012949

§ 371 Date: Aug. 30, 2019

(51) Int. Cl. H01Q 13/00; H01Q 1/48

(52) U.S. Cl. CPC H01Q 13/00; H01Q 1/48

(57) ABSTRACT

An antenna device is configured to include a first waveguide that is short-circuited to a ground conductor plate in such a way that an input output end thereof is connected to a first opening, and a second waveguide in which a first input output end thereof is connected to another input output end in the first waveguide, for deflecting the direction of an electric field of an electromagnetic wave supplied from the first input output end or a second input output end thereof in such a way that the direction of an electric field of an electromagnetic wave at the first input output end differs from the direction of an electric field of an electromagnetic wave at the second input output end by 90 degrees.

### TECHNICAL FIELD

The present disclosure relates to an antenna device.

### BACKGROUND ART

As an antenna device that emits electromagnetic waves, an antenna device including a triplate line is disclosed in following Patent Literature 1.

In this antenna device, a first conductive material plate in which an opening is provided at a center thereof, a second conductive material plate in which an opening is provided at a center thereof, and a third conductive material plate in which a cavity is provided at a center thereof are arranged in parallel while the plates are apart from one another by predetermined distances.

The position at which the cavity is provided corresponds to both the opening provided in the first conductive material plate and the opening provided in the second conductive material plate.

Further, in this antenna device, a first dielectric plate on which a first feed line is disposed is arranged between the first conductive material plate and the second conductive material plate.

A leading end of the first feed line disposed on the first dielectric plate is made to be open in the middle of the opening.

Further, in this antenna device, a second dielectric plate on which a second feed line is disposed is arranged between the second conductive material plate and the third conductive material plate.

A leading end of the second feed line disposed on the second dielectric plate is made to be open in the middle of the opening.

The first conductive material plate, the first feed line, and the third conductive material plate that are provided in this antenna device constitute a first triplate line.

Further, the second conductive material plate, the second feed line, and the third conductive material plate that are provided in this antenna device constitute a second triplate line.

An electromagnetic wave propagating through the first triplate line and an electromagnetic wave propagating through the second triplate line are emitted from the openings.

### CITATION LIST

### Patent Literature

Patent Literature 1: JP-A-Hei 8-130410

### SUMMARY OF INVENTION

### Technical Problem

The conventional antenna device includes the first dielectric plate and the second dielectric plate. Therefore, when electromagnetic waves are emitted from the openings after propagating through the first triplate line and the second triplate line, dielectric losses occur in the first dielectric plate and in the second dielectric plate. A problem is that, as a result, the power of the electromagnetic waves emitted from the antenna device decreases.

The present disclosure is made in order to solve the above-mentioned problem, and it is therefore an object of the present disclosure to provide an antenna device that can emit or receive an electromagnetic wave without providing a dielectric plate.

### Solution to Problem

An antenna device according to the present disclosure includes: a ground conductor plate in which a first opening is formed; a first waveguide that is short-circuited to the ground conductor plate in such a way that an input output end thereof is connected to the first opening; and a second waveguide in which a first input output end thereof is connected to another input output end in the first waveguide, for deflecting the direction of an electric field of an electromagnetic wave supplied from the first input output end or a second input output end thereof in such a way that the direction of an electric field of an electromagnetic wave at the first input output end differs from the direction of an electric field of an electromagnetic wave at the second input output end by 90 degrees.

### Advantageous Effects of Invention

According to the present disclosure, because the first waveguide that is short-circuited to the ground conductor plate in such a way that the input output end is connected to the first opening; and the second waveguide in which the first input output end thereof is connected to the other input output end in the first waveguide, for deflecting the direction of an electric field of an electromagnetic wave supplied from the first input output end or the second input output end in such a way that the direction of an electric field of an electromagnetic wave at the first input output end differs from the direction of an electric field of an electromagnetic wave at the second input output end by 90 degrees are included, there is provided an advantage of being able to emit or receive an electromagnetic wave without providing a dielectric plate.

### BRIEF DESCRIPTION OF DRAWINGS

FIG. 1 is a plan view showing an antenna device according to Embodiment 1 of the present disclosure;

FIG. 2 is a perspective view showing the antenna device according to Embodiment 1 of the present disclosure;

FIG. 3 is a side view showing the antenna device of FIG. 1 that is viewed from an x direction;

FIG. 4 is an exploded perspective view showing components associated with a horizontally polarized wave in the antenna device of FIG. 1;

FIG. 5 is an explanatory graph showing designed values and measured values of the reflection characteristic of a horizontally polarized wave emitted from the antenna device of FIG. 1;

FIG. 6 is an explanatory graph showing designed values and measured values of the reflection characteristic of a vertically polarized wave emitted from the antenna device of FIG. 1;

FIG. 7 is a plan view showing an antenna device according to Embodiment 2 of the present disclosure; and

FIG. 8 is a plan view showing another antenna device according to Embodiment 2 of the present disclosure.

### DESCRIPTION OF EMBODIMENTS

Hereafter, in order to explain the present disclosure in greater detail, embodiments of the present disclosure will be described with reference to accompanying drawings.

### Embodiment 1

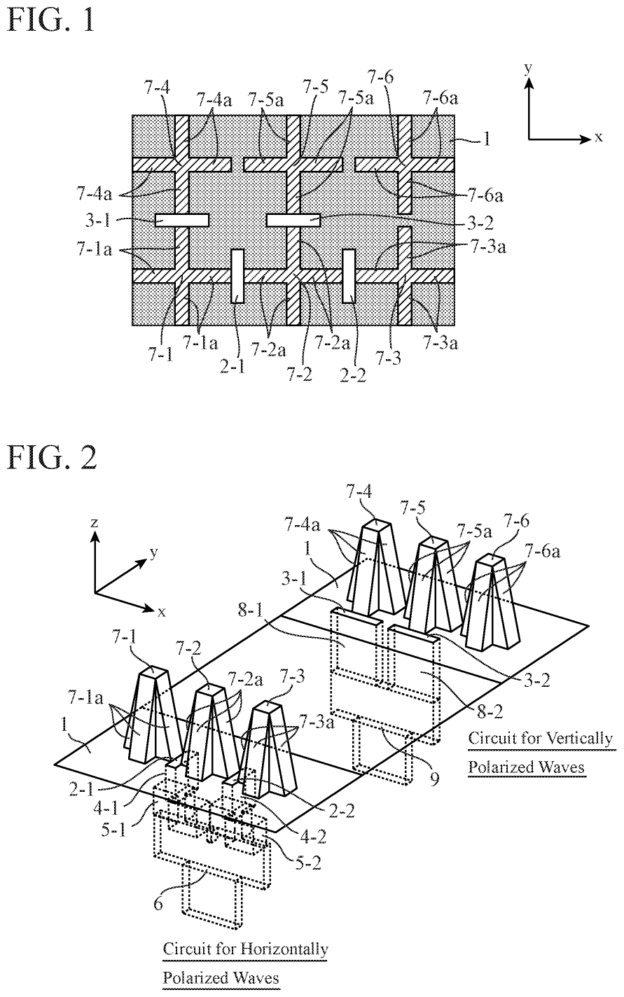

FIG. 1 is a plan view showing an antenna device according to Embodiment 1 of the present disclosure.

FIG. 2 is a perspective view showing the antenna device according to Embodiment 1 of the present disclosure.

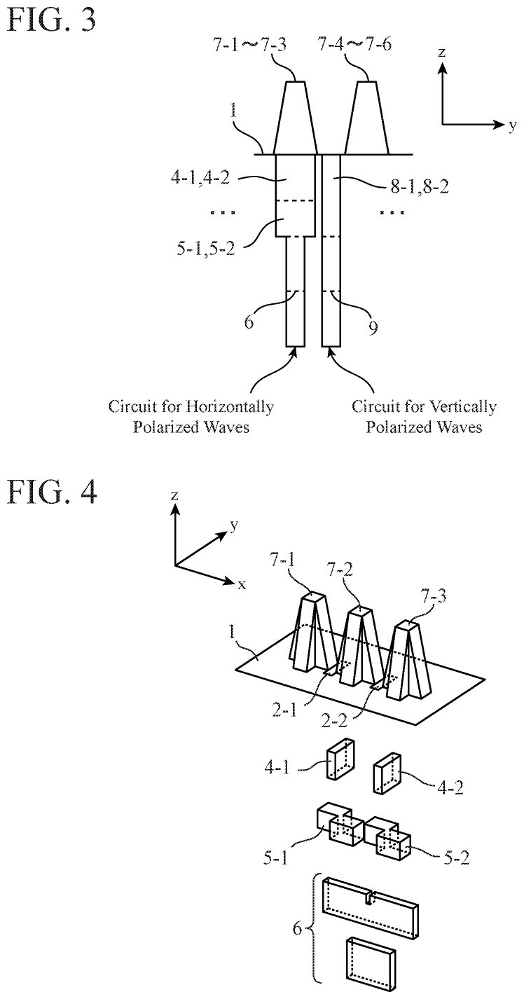

FIG. 3 is a side view showing the antenna device of FIG. 1 that is viewed from an x direction.

FIG. 4 is an exploded perspective view showing components associated with a horizontally polarized wave in the antenna device of FIG. 1.

In FIG. 2, in order to make the configuration of the antenna device intelligible, the antenna device is illustrated with spacing between a circuit for horizontally polarized waves and a circuit for vertically polarized waves, which will be mentioned later, being wider than that shown in FIG. 1.

In FIGS. 1 to 4, a ground conductor plate 1 is a flat-shaped conductor.

In the ground conductor plate 1, a first opening 2-1 and a first opening 2-2, and a second opening 3-1 and a second opening 3-2 are formed.

The first opening 2-1 and the first opening 2-2 are slots for emitting or receiving a horizontally polarized wave, and are arranged in the x direction in the figure.

The first opening 2-1 and the first opening 2-2 have a rectangular shape, and the longitudinal direction of the first opening 2-1 and the longitudinal direction of the first opening 2-2 are a y direction in the figure.

Although in this Embodiment 1 an example in which the two first openings including the first opening 2-1 and the first opening 2-2 are arranged in the x direction is explained, the number of first openings 2 may be one, or three or more first openings 2 may be arranged in the x direction.

In addition, two or more first openings 2 may be arranged also in the y direction, so that the first openings 2 may be arranged two-dimensionally.

The second opening 3-1 and the second opening 3-2 are slots for emitting or receiving a vertically polarized wave, and are arranged in the x direction in the figure.

The second opening 3-1 and the second opening 3-2 have a rectangular shape, and the longitudinal direction of the second opening 3-1 and the longitudinal direction of the second opening 3-2 are the x direction in the figure.

Although in this Embodiment 1 an example in which the two second openings including the second opening 3-1 and the second opening 3-2 are arranged in the x direction is explained, the number of second openings 3 may be one, or three or more second openings 3 may be arranged in the x direction.

In addition, two or more second openings 3 may be arranged also in the y direction, so that the second openings 3 may be arranged two-dimensionally.

A first waveguide 4-1 has two input output ends, one of the input output ends in the first waveguide 4-1 is on a side of a +z direction, and the other one of the input output ends in the first waveguide 4-1 is on a side of a −z direction.

The first waveguide 4-1 is short-circuited to the ground conductor plate 1 in such a way that the input output end on a side of the +z direction is connected to the first opening 2-1.

Because the size in the x direction in the first waveguide 4-1 is shorter than that in the y direction in the first waveguide, the first waveguide 4-1 is a rectangular one that can propagate an electromagnetic wave in which an electric field vector in the x direction is in a dominant mode.

A first waveguide 4-2 has two input output ends, one of the input output ends in the first waveguide 4-2 is on a side of the +z direction, and the other one of the input output ends in the first waveguide 4-2 is on a side of the −z direction. The first waveguide 4-2 is short-circuited to the ground conductor plate 1 in such a way that the input output end on a side of the +z direction is connected to the first opening 2-2.

Because the size in the x direction in the first waveguide 4-2 is shorter than that in the y direction in the first waveguide, the first waveguide 4-2 is a rectangular one that can propagate an electromagnetic wave in which an electric field vector in the x direction is in the dominant mode.

A second waveguide 5-1 has a first input output end and a second input output end, the first input output end in the second waveguide 5-1 is on a side of the +z direction, and the second input output end in the second waveguide 5-1 is on a side of the −z direction.

The second waveguide 5-1 is a twist waveguide in which the first input output end is connected to an opening on a side of the −z direction in the first waveguide 4-1, and which deflects the direction of the electric field of an electromagnetic wave supplied from the first input output end or the second input output end in such a way that the direction of the electric field of an electromagnetic wave at the first input output end differs from the direction of the electric field of an electromagnetic wave at the second input output end by 90 degrees.

A second waveguide 5-2 has a first input output end and a second input output end, the first input output end in the second waveguide 5-2 is on a side of the +z direction, and the second input output end in the second waveguide 5-2 is on a side of the −z direction.

The second waveguide 5-2 is a twist waveguide in which the first input output end is connected to an opening on a side of the −z direction in the first waveguide 4-2, and which deflects the direction of the electric field of an electromagnetic wave supplied from the first input output end or the second input output end in such a way that the direction of the electric field of an electromagnetic wave at the first input output end differs from the direction of the electric field of an electromagnetic wave at the second input output end by 90 degrees.

Each of the second waveguides 5-1 and 5-2 is only required to deflect the direction of the electric field of an electromagnetic wave by a right angle, and the shapes of the second waveguides 5-1 and 5-2 are not limited to the shapes as shown in FIGS. 2 and 4.

A first branch waveguide 6 has three input output ends, two of the input output ends in the first branch waveguide 6 are on a side of the +z direction, and the other one of the input output ends in the first branch waveguide 6 is on a side of the −z direction.

The first branch waveguide 6 is a T-branch waveguide in which one on a side of a −x direction in the two input output ends on a side of the +z direction is connected to the second input output end in the second waveguide 5-1, and the other one on a side of a +x direction in the two input output ends on a side of the +z direction is connected to the second input output end in the second waveguide 5-2.

Although in this Embodiment 1 an example in which the number of input output ends on a side of the +z direction in the first branch waveguide 6 is two is explained, the first branch waveguide 6 may have three or more input output ends as input output ends on a side of the +z direction in a case in which three or more second waveguides 5 are arranged in the x direction.

In this case, the three or more input output ends on a side of the +z direction in the first branch waveguide 6 are connected to the second input output ends in the three or more second waveguides 5, respectively.

Each of tapered conductors 7-1 to 7-6 has a taper shape in which a central portion thereof is raised in the +z direction, and is provided on a surface on a side of the +z direction of the ground conductor plate 1.

Each tapered conductor 7-n (n=1, 2, . . . , 6) includes four taper portions 7-na (n=1, 2, . . . , 6), and the four taper portions 7-na extend from the central portion of the tapered conductor 7-n toward the +x direction, the −x direction, a +y direction, and a −y direction.

The tapered conductors 7-1 to 7-3 are arranged side by side in the x direction in the figure, and the tapered conductors 7-4 to 7-6 are arranged in the x direction in the figure.

The tapered conductors 7-1 and 7-4 are arranged in the y direction in the figure, the tapered conductors 7-2 and 7-5 are arranged in the y direction in the figure, and the tapered conductors 7-3 and 7-6 are arranged in the y direction in the figure.

The tapered conductor 7-1 is connected to the first opening 2-1 and the second opening 3-1.

The tapered conductor 7-2 is connected to the first openings 2-1 and 2-2, and the second opening 3-2.

The tapered conductor 7-3 is connected to the first opening 2-2.

Thus, the first opening 2-1 is arranged between the tapered conductor 7-1 and the tapered conductor 7-2.

Further, the first opening 2-2 is arranged between the tapered conductor 7-2 and the tapered conductor 7-3.

The tapered conductor 7-4 is connected to the second opening 3-1.

The tapered conductor 7-5 is connected to the second opening 3-2.

Thus, the second opening 3-1 is arranged between the tapered conductor 7-1 and the tapered conductor 7-4.

Further, the second opening 3-2 is arranged between the tapered conductor 7-2 and the tapered conductor 7-5.

A third waveguide 8-1 has two input output ends, one of the input output ends in the third waveguide 8-1 is on a side of the +z direction, and the other one of the input output ends in the third waveguide 8-1 is on a side of the −z direction.

The third waveguide 8-1 is short-circuited to the ground conductor plate 1 in such a way that the input output end on a side of the +z direction is connected to the second opening 3-1.

Because the size in the x direction in the third waveguide 8-1 is greater than that in the y direction in the third waveguide, the third waveguide 8-1 is a rectangular one that can propagate an electromagnetic wave in which an electric field vector in the y direction is in the dominant mode.

A third waveguide 8-2 has two input output ends, one of the input output ends in the third waveguide 8-2 is on a side of the +z direction, and the other one of the input output ends in the third waveguide 8-2 is on a side of the −z direction.

The third waveguide 8-2 is short-circuited to the ground conductor plate 1 in such a way that the input output end on a side of the +z direction is connected to the second opening 3-2.

Because the size in the x direction in the third waveguide 8-2 is greater than that in the y direction in the third waveguide, the third waveguide 8-2 is a rectangular one that can propagate an electromagnetic wave in which an electric field vector in the y direction is in the dominant mode.

A second branch waveguide 9 has three input output ends, two of the input output ends in the second branch waveguide 9 are on a side of the +z direction, and the other one of the input output ends in the second branch waveguide 9 is on a side of the −z direction.

The second branch waveguide 9 is a T-branch waveguide in which one on a side of the −x direction in the two input output ends on a side of the +z direction is connected to the input output end on a side of the −z direction in the third waveguide 8-1, and the other one on a side of the +x direction in the two input output ends on a side of the +z direction is connected to the input output end on a side of the −z direction in the third waveguide 8-2.

Although in this Embodiment 1 an example in which the number of input output ends on a side of the +z direction in the second branch waveguide 9 is two is explained, the second branch waveguide 9 may have three or more input output ends as input output ends on a side of the +z direction in a case in which three or more third waveguides 8 are arranged in the x direction.

In this case, the three or more input output ends on a side of the +z direction in the second branch waveguide 9 are connected to the input output ends on a side of the −z direction in the three or more third waveguides 8, respectively.

A circuit constituted by the first waveguides 4-1 and 4-2, the second waveguides 5-1 and 5-2, and the first branch waveguide 6 is the circuit for horizontally polarized waves for emitting or receiving a horizontally polarized wave.

Further, a circuit constituted by the third waveguides 8-1 and 8-2, and the second branch waveguide 9 is the circuit for vertically polarized waves for emitting or receiving a vertically polarized wave.

The circuit for horizontally polarized waves and the circuit for vertically polarized waves can be produced by forming all the waveguides that constitute the circuits by performing cutting on multiple metal blocks sliced in the y direction or the z direction, and layering all the formed waveguides by fastening them with screws or brazing.

Next, operations will be explained.

First, an operation in a case in which the circuit for horizontally polarized waves is used as an antenna for transmission will be explained.

An electromagnetic wave in which an electric field vector in the y direction is in the dominant mode is fed from the input output end on a side of the −z direction in the first branch waveguide 6.

The power of this electromagnetic wave is divided into two parts after the electromagnetic wave is propagated toward the +z direction through space in the first branch waveguide 6.

One of the electromagnetic waves divided by the first branch waveguide 6 is emitted from the input output end on a side of the −x direction of the two input output ends on a side of the +z direction to the second waveguide 5-1.

Further, the other one of the electromagnetic waves divided by the first branch waveguide 6 is emitted from the input output end on a side of the +x direction of the two input output ends on a side of the +z direction to the second waveguide 5-2.

Because the second waveguide 5-1 is a twist waveguide, the direction of the electric field vector of the electromagnetic wave emitted from the first branch waveguide 6 is deflected by a right angle when being propagated through space in the second waveguide 5-1.

Therefore, the electromagnetic wave in which the electric field vector in the x direction is in the dominant mode is emitted from the first input output end of the second waveguide 5-1 that is the input output end on a side of the +z direction to the first waveguide 4-1.

Because the second waveguide 5-2 is a twist waveguide, the direction of the electric field vector of the electromagnetic wave emitted from the first branch waveguide 6 is deflected by a right angle when being propagated through space in the second waveguide 5-2.

Therefore, the electromagnetic wave in which the electric field vector in the x direction is in the dominant mode is emitted from the first input output end of the second waveguide 5-2 that is the input output end on a side of the +z direction to the first waveguide 4-2.

The electromagnetic wave which is emitted from the second waveguide 5-1 and in which the electric field vector in the x direction is in the dominant mode is propagated toward the +z direction through space in the first waveguide 4-1.

Further, the electromagnetic wave which is emitted from the second waveguide 5-2 and in which the electric field vector in the x direction is in the dominant mode is propagated toward the +z direction through space in the first waveguide 4-2.

The electromagnetic wave which is propagated through the space in the first waveguide 4-1 and in which the electric field vector in the x direction is in the dominant mode is emitted from the first opening 2-1 to space, and the electromagnetic wave which is propagated through the space in the first waveguide 4-2 and in which the electric field vector in the x direction is in the dominant mode is emitted from the first opening 2-2 to space.

Further, the electromagnetic waves which are propagated through the space in the first waveguide 4-1 and the space in the first waveguide 4-2 and in each of which the electric field vector in the x direction is in the dominant mode are emitted to the space via the tapered conductors 7-1 to 7-3.

The tapered conductors 7-1 to 7-3 serve as a matching circuit for providing matching between the impedance in the first waveguides 4-1 and 4-2 and the impedance of the space. Therefore, the tapered conductors 7-1 to 7-3 contribute to band broadening of the antenna device.

Next, an operation in a case in which the circuit for horizontally polarized waves is used as an antenna for reception will be explained.

An electromagnetic wave which is propagated through space and in which an electric field vector in the x direction is in the dominant mode is incident on the first waveguide 4-1 from the first opening 2-1.

Further, an electromagnetic wave which is propagated through space and in which an electric field vector in the x direction is in the dominant mode is incident on the first waveguide 4-2 from the first opening 2-2.

The electromagnetic wave incident on the first waveguide 4-1 is emitted from the input output end on a side of the −z direction to the second waveguide 5-1 after being propagated toward the −z direction.

Further, the electromagnetic wave incident on the first waveguide 4-2 is emitted from the input output end on a side of the −z direction to the second waveguide 5-2 after being propagated toward the −z direction.

Because the second waveguide 5-1 is a twist waveguide, the direction of the electric field vector of the electromagnetic wave emitted from the first waveguide 4-1 is deflected by a right angle when being propagated through the space in the second waveguide 5-1.

Therefore, the electromagnetic wave in which the electric field vector in the y direction is in the dominant mode is emitted from the second input output end of the second waveguide 5-1 that is the input output end on a side of the −z direction to the first branch waveguide 6.

Because the second waveguide 5-2 is a twist waveguide, the direction of the electric field vector of the electromagnetic wave emitted from the first waveguide 4-2 is deflected by a right angle when being propagated through the space in the second waveguide 5-2.

Therefore, the electromagnetic wave in which the electric field vector in the y direction is in the dominant mode is emitted from the second input output end of the second waveguide 5-2 that is the input output end on a side of the −z direction to the first branch waveguide 6.

The power of the electromagnetic wave which is emitted from the second waveguide 5-1 and in which the electric field vector in the y direction is in the dominant mode and the power of the electromagnetic wave which is emitted from the second waveguide 5-2 and in which the electric field vector in the y direction is in the dominant mode are combined in the first branch waveguide 6.

An electromagnetic wave having the composite power in which the electric field vector in the y direction is in the dominant mode is emitted from the input output end on a side of the −z direction of the first branch waveguide 6.

Next, an operation in a case in which the circuit for vertically polarized waves is used as an antenna for transmission will be explained.

An electromagnetic wave in which an electric field vector in the y direction is in the dominant mode is fed from the input output end on a side of the −z direction in the second branch waveguide 9.

The power of this electromagnetic wave is divided into two parts after the electromagnetic wave is propagated toward the +z direction through space in the second branch waveguide 9.

One of the electromagnetic waves divided by the second branch waveguide 9 is emitted from the input output end on a side of the −x direction of the two input output ends on a side of the +z direction to the third waveguide 8-1.

Further, the other one of the electromagnetic waves divided by the second branch waveguide 9 is emitted from the input output end on a side of the +x direction of the two input output ends on a side of the +z direction to the third waveguide 8-2.

The electromagnetic wave which is emitted from the second branch waveguide 9 and in which the electric field vector in the y direction is in the dominant mode is propagated toward the +z direction through space in the third waveguide 8-1.

The electromagnetic wave which is propagated through the space in the third waveguide 8-1 and in which the electric field vector in the y direction is in the dominant mode is emitted from the second opening 3-1 to space. Further, the electromagnetic wave which is propagated through the space in the third waveguide 8-1 and in which the electric field vector in the y direction is in the dominant mode is emitted to the space via the tapered conductors 7-1 and 7-4.

The tapered conductors 7-1 and 7-4 serve as a matching circuit for providing matching between the impedance in the third waveguide 8-1 and the impedance of the space. Therefore, the tapered conductors 7-1 and 7-4 contribute to band broadening of the antenna device.

The electromagnetic wave which is emitted from the second branch waveguide 9 and in which the electric field vector in the y direction is in the dominant mode is propagated toward the +z direction through space in the third waveguide 8-2.

The electromagnetic wave which is propagated through the space in the third waveguide 8-2 and in which the electric field vector in the y direction is in the dominant mode is emitted from the second opening 3-2 to the space. Further, the electromagnetic wave which is propagated through the space in the third waveguide 8-2 and in which the electric field vector in the y direction is in the dominant mode is emitted to the space via the tapered conductors 7-2 and 7-5.

The tapered conductors 7-2 and 7-5 serve as a matching circuit for providing matching between the impedance in the third waveguide 8-2 and the impedance of the space. Therefore, the tapered conductors 7-2 and 7-5 contribute to band broadening of the antenna device.

Next, an operation in a case in which the circuit for vertically polarized waves is used as an antenna for reception will be explained.

An electromagnetic wave which is propagated through space and in which an electric field vector in the y direction is in the dominant mode is incident on the third waveguide 8-1 from the second opening 3-1.

Further, an electromagnetic wave which is propagated through the space and in which an electric field vector in the y direction is in the dominant mode is incident on the third waveguide 8-2 from the second opening 3-2.

The electromagnetic wave incident on the third waveguide 8-1 is emitted from the input output end on a side of the −z direction of the third waveguide 8-1 to the second branch waveguide 9 after being propagated toward the −z direction.

Further, the electromagnetic wave incident on the third waveguide 8-2 is emitted from the input output end on a side of the −z direction of the third waveguide 8-2 to the second branch waveguide 9 after being propagated toward the −z direction.

The power of the electromagnetic wave which is emitted from the third waveguide 8-1 and in which the electric field vector in the y direction is in the dominant mode and the power of the electromagnetic wave which is emitted from the third waveguide 8-2 and in which the electric field vector in the y direction is in the dominant mode are combined in the second branch waveguide 9.

An electromagnetic wave having the composite power in which the electric field vector in the y direction is in the dominant mode is emitted from the input output end on a side of the −z direction of the second branch waveguide 9.

Hereafter, the electrical characteristics of the antenna device of FIG. 1 will be explained.

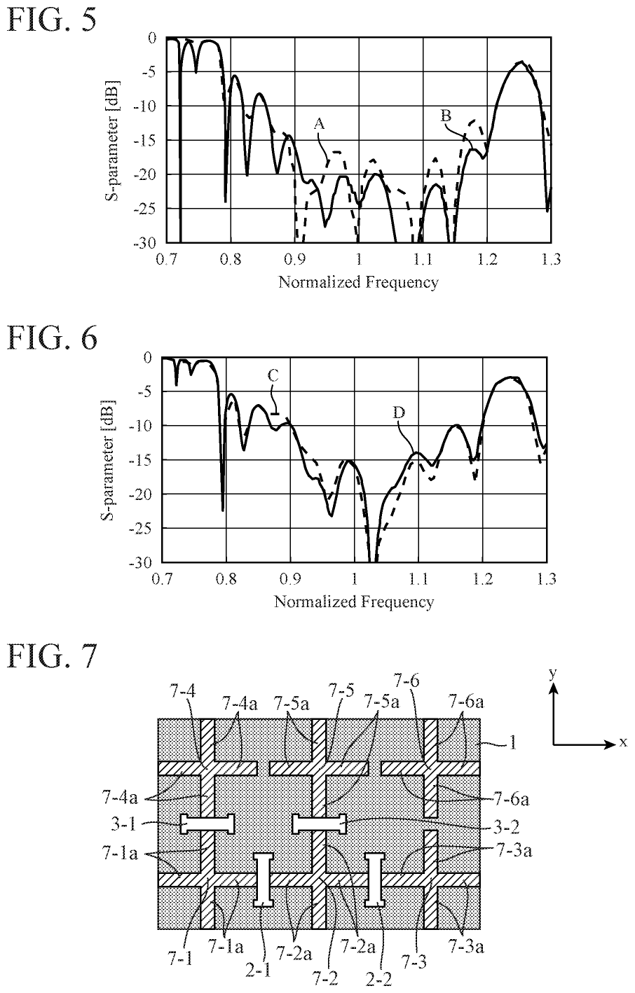

FIG. 5 is an explanatory graph showing designed values and measured values of the reflection characteristic of a horizontally polarized wave emitted from the antenna device of FIG. 1.

FIG. 6 is an explanatory graph showing designed values and measured values of the reflection characteristic of a vertically polarized wave emitted from the antenna device of FIG. 1.

The measured values shown in FIGS. 5 and 6 are results of an electromagnetic field simulation performed on the antenna device of FIG. 1, or experimental results.

In FIG. 5, a curve A shows designed values of the reflection characteristic of a horizontally polarized wave, and a curve B shows measured values of the reflection characteristic of a horizontally polarized wave.

In FIG. 6, a curve C shows designed values of the reflection characteristic of a vertically polarized wave, and a curve D shows measured values of the reflection characteristic of a vertically polarized wave.

The horizontal axes of FIGS. 5 and 6 show normalized frequencies.

The vertical axis of FIG. 5 shows a reflection coefficient (S11) of a horizontally polarized wave, and the vertical axis of FIG. 6 shows a reflection coefficient (S11) of a vertically polarized wave.

It is confirmed that bands in which the reflection coefficient (S11) of a horizontally polarized wave is equal to or less than −10 dB account for approximately 37%, as shown in FIG. 5, and bands in which the reflection coefficient (S11) of a vertically polarized wave is equal to or less than −10 dB account for approximately 25%, as shown in FIG. 6.

All the components of the antenna device of FIG. 1 are made of metal. Therefore, the antenna device of FIG. 1 has a smaller loss in the power of an electromagnetic wave emitted or received than that of an antenna device including a dielectric.

It is verified that in a case in which, for example, all the components of the antenna device of FIG. 1 are made of aluminum materials, the loss in the power of an electromagnetic wave emitted or received in the frequency range of the X band is as small as 0.05 dB.

As is clear from the above description, according to this Embodiment 1, because the first waveguide 4-1 that is short-circuited to the ground conductor plate 1 in such a way that one of the input output ends thereof is connected to the first opening 2-1, and the second waveguide 5-1 in which the first input output end thereof is connected to the other input output end in the first waveguide 4-1, and which deflects the direction of the electric field of an electromagnetic wave fed from the first input output end or the second input output end thereof in such a way that the direction of the electric field of an electromagnetic wave at the first input output end differs from the direction of the electric field of an electromagnetic wave at the second input output end by 90 degrees are included, an electromagnetic wave can be emitted or received without disposing a dielectric plate. As a result, degradation in the power of an electromagnetic wave emitted or received can be prevented.

Further, according to this Embodiment 1, because the third waveguide 8-1 that is short-circuited to the ground conductor plate 1 in such a way that one of the input output ends thereof is connected to the second opening 3-1 is included, there is provided an advantage of being able to emit or receive both a horizontally polarized wave and a vertically polarized wave that are two polarized waves perpendicular to each other.

Further, according to this Embodiment 1, because the first branch waveguide 6 having multiple input output ends connected to the second input output ends in the second waveguides 5-1 and 5-2, and the second branch waveguide 9 having multiple input output ends connected to the other input output ends in the third waveguides 8-1 and 8-2 are included, an array antenna in which multiple antenna elements are arranged two-dimensionally can be configured.

Although in this Embodiment 1 the example in which each of the four taper portions 7-1a to 7-6a in the tapered conductors 7-1 to 7-6 is inclined linearly is shown, this embodiment is not limited to this example.

For example, each of the four taper portions 7-1a to 7-6a in the tapered conductors 7-1 to 7-6 may be a curvilinear tapered portion whose change in inclination is defined by an exponential function.

Although the tapered conductors 7-1 to 7-6 are disposed in order to achieve band broadening of the antenna device, the tapered conductors 7-1 to 7-6 are not indispensable components. Therefore, the tapered conductors 7-1 to 7-6 may be eliminated in order to shorten the length in the z direction of the antenna device, thereby achieving a low height of the antenna device.

In this Embodiment 1, the example in which two openings used as antenna elements are arranged in the x direction, and two openings used as antenna elements are arranged in the y direction is shown. More specifically, the example in which the first openings 2-1 and 2-2 and the second openings 3-1 and 3-2 are formed in the ground conductor plate 1 is shown.

However, this is only an example, and the number of openings arranged in the x direction may be one, or three or more. Further, the number of openings arranged in the y direction may be one, or three or more.

In this Embodiment 1, although the example in which the shape of the first openings 2-1 and 2-2 and the shape of the second openings 3-1 and 3-2 are rectangular is shown, this embodiment is not limited to this example.

For example, the four corners of each of the first openings 2-1 and 2-2 and the four corners of each of the second openings 3-1 and 3-2 may be rounded by performing machine cutting.

Further, although in this Embodiment 1 the example in which the longitudinal direction of the first openings 2-1 and 2-2 is the y direction and the longitudinal direction of the second openings 3-1 and 3-2 is the x direction is shown, the longitudinal direction of the first openings 2-1 and 2-2 may be inclined with respect to the y direction and the longitudinal direction of the second openings 3-1 and 3-2 may be inclined with respect to the x direction.

In a case in which the longitudinal direction of the first openings 2-1 and 2-2 is inclined with respect to the y direction, the circuit for horizontally polarized waves is also inclined with respect to the y direction. Further, in a case in which the longitudinal direction of the second openings 3-1 and 3-2 is inclined with respect to the x direction, the circuit for vertically polarized waves is also inclined with respect to the x direction.

Although in this Embodiment 1 the example in which the first openings 2-1 and 2-2 and the second openings 3-1 and 3-2 are arranged at equal intervals both in the x direction and in the y direction, this embodiment is not limited to this example.

For example, the intervals in the arrangement in the x direction or in the y direction, out of the intervals in the arrangement of the first opening 2-1 and 2-2 and the intervals in the arrangement of the second opening 3-1 and 3-2, may be unequal. As an alternative, both the intervals in the arrangement in the x direction and the intervals in the arrangement in the y direction may be unequal.

Although in this Embodiment 1 the antenna device that can emit or receive both a horizontally polarized wave and a vertically polarized wave that are two polarized waves perpendicular to each other is shown, the circuit for vertically polarized waves that is constituted by the third waveguides 8-1 and 8-2 and the second branch waveguide 9 may be eliminated so that the antenna device is configured as an antenna device for single polarization excitation that emits or receives only a horizontally polarized wave.

As an alternative, the circuit for horizontally polarized waves that is constituted by the first waveguides 4-1 and 4-2, the second waveguides 5-1 and 5-2, and the first branch waveguide 6 may be eliminated so that the antenna device is configured as an antenna device for single polarization excitation that emits or receives only a vertically polarized wave.

Although in this Embodiment 1 the antenna device that can emit or receive both a horizontally polarized wave and a vertically polarized wave that are two polarized waves perpendicular to each other is shown, a meander line polarizer may be arranged in the +z direction of the antenna device of FIG. 1 so that the antenna device is configured as an antenna device that emits or receives a circularly polarized wave.

### Embodiment 2

There are many cases in which the length in the longitudinal direction in each of the first openings 2-1 and 2-2 formed in the ground conductor plate 1, and the length in the longitudinal direction in each of the second openings 3-1 and 3-2 formed in the ground conductor plate are set to approximately one-half of the wavelength of an electromagnetic wave emitted or received.

In a case in which the length in the longitudinal direction is set to approximately one-half of the wavelength of an electromagnetic wave, and two or more first openings 2 are arranged two-dimensionally and two or more second openings 3 are arranged two-dimensionally, the length of the intervals in the x direction between the two or more first openings 2 is 0.5 or more of the wavelength and the length of the intervals in the y direction between the two or more first openings 2 is 0.5 or more of the wavelength.

Further, the length of the intervals in the x direction between the two or more second openings 3 is 0.5 or more of the wavelength, and the length of the intervals in the y direction between the two or more second openings 3 is 0.5 or more of the wavelength.

In a case in which the first openings 2 and the second openings 3 are used as antenna elements and the length of the intervals between the antenna elements is 0.5 or more of the wavelength, an unnecessary electromagnetic wave called a grating lobe may be emitted depending on the orientation of an electromagnetic wave. The emission of a grating lobe occurs more easily as the length of the intervals between the antenna elements becomes longer. Therefore, the shorter length the intervals between the antenna elements have, the further the possibility of emission of a grating lobe can be reduced.

Accordingly, in this Embodiment 2, the length in the longitudinal direction in each of the first openings 2-1 and 2-2 and the length in the longitudinal direction in each of the second openings 3-1 and 3-2 are made to be shorter than those in above-mentioned Embodiment 1 so that the length of the intervals between the antenna elements is reduced.

Concretely, the lengths in the longitudinal direction are made to be shorter than those in above-mentioned Embodiment 1 by shaping the first openings 2-1 and 2-2 and the second openings 3-1 and 3-2 into a letter I, as shown in FIG. 7.

FIG. 7 is a plan view showing an antenna device according to Embodiment 2 of the present disclosure.

By shaping the first openings 2-1 and 2-2 and the second openings 3-1 and 3-2 into a letter I, and making their lengths in the longitudinal direction be shorter than those in above-mentioned Embodiment 1, the length of the intervals between the antenna elements can be made to be shorter than that in above-mentioned Embodiment 1.

In the case in which the first openings 2-1 and 2-2 and the second openings 3-1 and 3-2 are shaped into a letter I, the lengths in the lateral direction are longer than those in the case in which their shapes are rectangular.

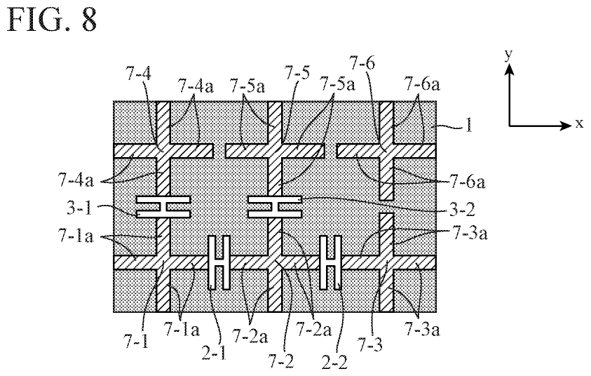

Although the example in which the first openings 2-1 and 2-2 and the second openings 3-1 and 3-2 are shaped into a letter I is shown above, the first openings 2-1 and 2-2 and the second openings 3-1 and 3-2 may be shaped into a letter H, as shown in FIG. 8.

FIG. 8 is a plan view showing another antenna device according to Embodiment 2 of the present disclosure.

By shaping the first openings 2-1 and 2-2 and the second openings 3-1 and 3-2 into a letter H, and making their lengths in the longitudinal direction be shorter than those in above-mentioned Embodiment 1, the length of the intervals between the antenna elements can be made to be shorter than that in above-mentioned Embodiment 1.

In the case in which the first openings 2-1 and 2-2 and the second openings 3-1 and 3-2 are shaped into a letter H, the lengths in the lateral direction are longer than those in the case in which their shapes are rectangular.

It is to be understood that any combination of two or more of the above-mentioned embodiments can be made, various changes can be made in any component according to any one of the above-mentioned embodiments, and any component according to any one of the above-mentioned embodiments can be omitted within the scope of the present disclosure.

### INDUSTRIAL APPLICABILITY

The present disclosure is suitable for antenna devices including waveguides.

### REFERENCE SIGNS LIST

1 ground conductor plate, 2-1, 2-2 first opening, 3-1, 3-2 second opening, 4-1, 4-2 first waveguide, 5-1, 5-2 second waveguide, 6 first branch waveguide, 7-1 to 7-6 tapered conductor, 7-1a to 7-6a taper portion, 8-1, 8-2 third waveguide, and 9 second branch waveguide.

1. An antenna device comprising:
a ground conductor plate in which a first opening is formed;
a first waveguide that is short-circuited to the ground conductor plate in such a way that an input output end thereof is connected to the first opening; and
a second waveguide in which a first input output end thereof is connected to another input output end in the first waveguide, to deflect a direction of an electric field of an electromagnetic wave supplied from the first input output end or a second input output end thereof in such a way that a direction of an electric field of an electromagnetic wave at the first input output end differs from a direction of an electric field of an electromagnetic wave at the second input output end by 90 degrees.

2. The antenna device according to claim 1,
wherein a second opening whose longitudinal direction is perpendicular to that of the first opening is formed in the ground conductor plate, and
wherein the antenna device comprises at least one third waveguide that is short-circuited to the ground conductor plate in such a way that one input output end thereof is connected to the second opening.

3. The antenna device according to claim 2,
wherein the at least one third waveguide comprises multiple third waveguides, and
wherein the antenna device comprises a second branch waveguide having multiple input output ends connected to respective other input output ends of the multiple third waveguides.

4. The antenna device according to claim 2,
wherein the first opening and the second opening are I-shaped.

5. The antenna device according to claim 2, wherein the first opening and the second opening are H-shaped.
